(19) United States
(12) Patent Application Publication
(10) Pub. No.: US 2024/0337730 A1
(43) Pub. Date: Oct. 10, 2024

(54) LIGHT SOURCE DEVICE, DISTANCE MEASURING DEVICE, AND DISTANCE MEASURING METHOD

(71) Applicant: SONY SEMICONDUCTOR SOLUTIONS CORPORATION, KANAGAWA (JP)

(72) Inventors: TAKUYA YOKOYAMA, KANAGAWA (JP); SHUNPEI SUZUKI, KANAGAWA (JP)

(21) Appl. No.: 18/574,724

(22) PCT Filed: Mar. 11, 2022
(86) PCT No.: PCT/JP2022/010861

§ 371 Date: Dec. 27, 2023

(30) Foreign Application Priority Data
Jul. 6, 2021 (JP) 2021-112230

(51) Int. Cl. G01S 7/481; G01S 7/4865; G01S 17/931

(52) U.S. Cl. CPC G01S 7/4815; G01S 7/4816; G01S 7/4817; G01S 7/4865; G01S 17/931

(57) ABSTRACT

The light source device includes a light emitting unit, a scanning unit, and a controller. In the light emitting unit, a plurality of light emitting elements is arranged along a first direction. The scanning unit scans light emitted from the plurality of light emitting elements along the second direction orthogonal to the first direction. The controller performs control to make the number of times of light emission of the first light emitting element group included in the plurality of light emitting elements larger than the number of times of light emission of the second light emitting element group not included in the first light emitting element group.

### FIELD

The present disclosure relates to a light source device, a distance measuring device, and a distance measuring method.

### BACKGROUND

Conventionally, there is a distance measuring device that measures a distance to an object that is a reflector by emitting a laser beam to the outside and receiving reflected light, such as light detection and ranging (LiDAR). In this type of distance measuring device, there may be a case to increase the number of times of measurement of a more important region in order to improve the accuracy of distance measurement (see, for example, Patent Literature 1).

### CITATION LIST

### Patent Literature

Patent Literature 1: JP 2017-15404 A

### SUMMARY

### Technical Problem

However, in the conventional technique, although the accuracy in the scanning direction can be improved, there is an issue that the accuracy cannot be increased with respect to the direction orthogonal to the scanning direction.

Therefore, the present disclosure proposes a light source device, a distance measuring device, and a distance measuring method capable of performing distance measurement with high accuracy in the direction orthogonal to the scanning direction.

### Solution to Problem

In order to solve the above problem, a light source device according to one embodiment of the present disclosure includes: a light emitting unit in which a plurality of light emitting elements are arranged along a first direction; a scanning unit that scans light emitted from the plurality of light emitting elements along a second direction orthogonal to the first direction; and a controller that performs control to make the number of times of light emission of a first light emitting element group included in the plurality of light emitting elements larger than the number of times of light emission of a second light emitting element group not included in the first light emitting element group.

### BRIEF DESCRIPTION OF DRAWINGS

FIG. 1 is a block diagram illustrating a schematic configuration example of a ToF sensor as a distance measuring device according to the present embodiment.

FIG. 2 is a diagram for explaining an optical system of the ToF sensor according to the present embodiment.

FIG. 3 is a block diagram illustrating a schematic configuration example of a light receiving unit according to the present embodiment.

FIG. 4 is a schematic diagram illustrating a schematic configuration example of an LD array and a SPAD array according to the present embodiment.

FIG. 5 is a circuit diagram illustrating a schematic configuration example of a SPAD pixel according to the present embodiment.

FIG. 6 is a block diagram illustrating a more detailed configuration example of a SPAD addition unit according to the present embodiment.

FIG. 7 is a diagram illustrating a histogram generated by a calculation unit.

FIG. 8 is a diagram for explaining a region detected by the LD array and the SPAD array.

FIG. 9 is a diagram illustrating a relationship between distance measured and emission intensity.

FIG. 10 is a diagram illustrating a relationship between distance measured, emission intensity, and the number of times of measurement.

FIG. 11 is a diagram illustrating an installation position of a ToF sensor according to Modification 1.

FIG. 12 is a diagram illustrating an installation position of a ToF sensor according to Modification 2.

FIG. 13 is a flowchart illustrating a processing procedure of entire processing executed by the ToF sensor.

FIG. 14 is a block diagram illustrating an example of a schematic configuration of a vehicle control system.

FIG. 15 is an explanatory diagram illustrating an example of installation positions of an outside-vehicle information detector and an imaging unit.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Furthermore, in the specification and the drawings, a plurality of constituent elements having substantially the same functional configuration may be distinguished from one another by adding different numbers after the same reference numeral. However, if it is not necessary to distinguish the plurality of constituent elements having substantially the same functional configuration from one another, only the same reference numeral is given.

Note that the description will be given in the following order.
1. Embodiment
1.1 Distance Measuring Device (ToF Sensor)
1.2 Optical System
1.3 Light Receiving Unit
1.4 LD Array and SPAD Array
1.5 SPAD Pixel
1.6 Schematic Operation Example of SPAD Pixel
1.7 SPAD Addition Unit
1.8 Sampling Cycle
1.9 Histogram
1.10 Region to be Detected
1.11 Number of Times of Detection
2. Application Example
3. Summary

### 1. EMBODIMENT

First, an embodiment will be described in detail below with reference to the drawings.

### 1.1 Distance Measuring Device (ToF Sensor)

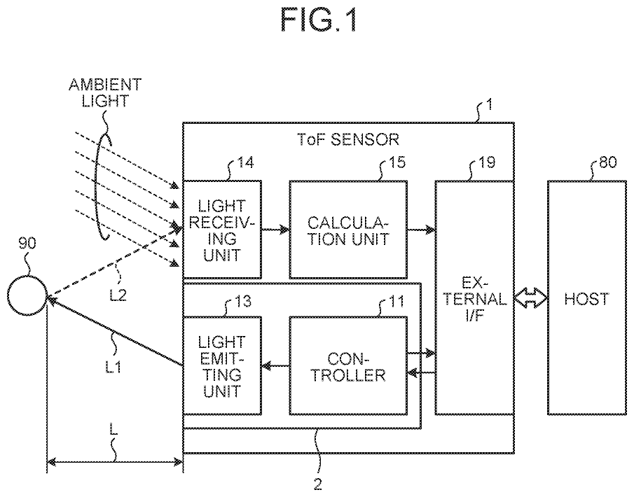

FIG. 1 is a block diagram illustrating a schematic configuration example of a ToF sensor as a distance measuring device according to the present embodiment. As illustrated in FIG. 1, the ToF sensor 1 includes a controller 11, a light emitting unit 13, a light receiving unit 14, a calculation unit 15, and an external interface (I/F) 19. The controller 11 and the light emitting unit 13 are included in the light source device 2.

The controller 11 includes, for example, an information processing apparatus such as a central processing unit (CPU) and controls each unit of the ToF sensor 1.

The external I/F 19 may be, for example, a communication adapter for establishing communication with the external host 80 via a communication network conforming to an arbitrary standard such as a controller area network (CAN), a local interconnect network (LIN), or FlexRay (registered trademark) in addition to a wireless local area network (LAN) or a wired LAN.

Here, for example, in a case where the ToF sensor 1 is mounted on a mobile body such as an automobile, the host 80 may be an engine control unit (ECU) mounted on an automobile or the like. Furthermore, in a case where the ToF sensor 1 is mounted on an autonomous mobile robot such as a domestic pet robot or an autonomous mobile body such as a robot cleaner, an unmanned aerial vehicle, or a following conveyance robot, the host 80 may be a control device or the like that controls the autonomous mobile body.

Although details will be described later, the light emitting unit 13 includes, for example, semiconductor laser diodes as a plurality of light emitting elements arranged in a one-dimensional array along the vertical direction (first direction) as a light source, and emits a pulsed laser beam L1 having a predetermined time width at a predetermined cycle (also referred to as a light emission cycle). In addition, the light emitting unit 13 emits the laser beam L1 having a time width of 1 ns (nanosecond) at a cycle of 1 MHz (megahertz), for example. For example, in a case where an object 90 is present within the distance measurement range, the laser beam L1 emitted from the light emitting unit 13 is reflected by the object 90 and enters the light receiving unit 14 as reflected light L2.

Although details will be described later, the light receiving unit 14 includes, for example, SPAD pixels that are a plurality of light receiving elements arranged in a two-dimensional lattice pattern and each receiving light from a plurality of semiconductor laser diodes, and outputs information regarding the number (for example, corresponding to the number of detection signals to be described later) of SPAD pixels (hereinafter, referred to as the number of detections) in which incidence of photons has been detected after light emission by the light emitting unit 13. For example, the light receiving unit 14 detects incidence of photons at a predetermined sampling cycle for one light emission of the light emitting unit 13 and outputs the number of detected photons.

The calculation unit 15 aggregates the number of detections output from the light receiving unit 14 for each of a plurality of SPAD pixels (for example, corresponding to one or a plurality of macro pixels to be described later), and creates a histogram in which the horizontal axis is the time-of-flight and the vertical axis is the accumulated pixel value on the basis of the pixel values obtained by the aggregation. For example, the calculation unit 15 repeatedly executes, for a plurality of times of light emission of the light emitting unit 13, obtaining a pixel value by aggregating the number of detections at a predetermined sampling frequency for one light emission of the light emitting unit 13, thereby creating a histogram in which the horizontal axis (bin of the histogram) is a sampling cycle corresponding to the time-of-flight and the vertical axis is an accumulated pixel value obtained by accumulating pixel values obtained in each sampling cycle.

In addition, after performing predetermined filter processing on the created histogram, the calculation unit 15 specifies the time-of-flight when the accumulated pixel value reaches the peak from the histogram after the filter processing. Then, the calculation unit 15 calculates the distance from the ToF sensor 1 or the device equipped with the ToF sensor 1 to the object 90 present within the distance measurement range on the basis of the specified time-of-flight. Note that the information on the distance calculated by the calculation unit 15 may be output to the host 80 or the like via the external I/F 19, for example.

### 1.2 Optical System

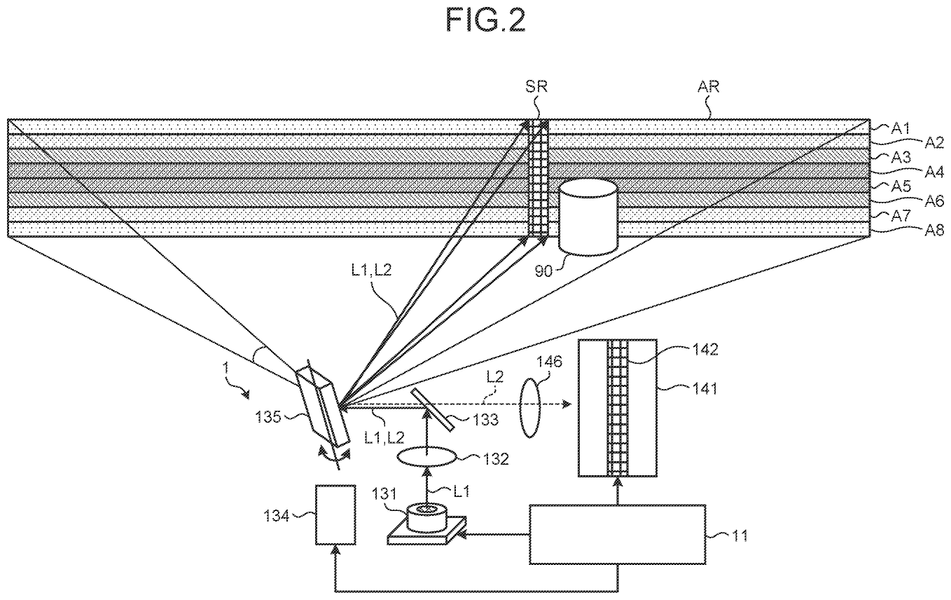

FIG. 2 is a diagram for explaining an optical system of the ToF sensor according to the present embodiment. FIG. 2 illustrates a so-called scanning type optical system that scans the angle of view of the light receiving unit 14 in the horizontal direction.

As illustrated in FIG. 2, the ToF sensor 1 includes, as an optical system, an LD array 131, a collimator lens 132, a half mirror 133, a galvano mirror 135, a light receiving lens 146, and a SPAD array 141. The LD array 131, the collimator lens 132, the half mirror 133, and the galvano mirror 135 are included in, for example, the light emitting unit 13 in FIG. 1. Furthermore, the light receiving lens 146 and the SPAD array 141 are included in the light receiving unit 14 in FIG. 1, for example.

In the configuration illustrated in FIG. 2, the collimator lens 132 converts the laser beam L1 emitted from the LD array 131 into rectangular parallel beam having an intensity spectrum of a cross section that is long in the vertical direction, and then the laser beam L1 enters the half mirror 133. The half mirror 133 reflects a part of the incident laser beam L1. The laser beam L1 reflected by the half mirror 133 is incident on the galvano mirror 135. For example, the galvano mirror 135 vibrates in the horizontal direction about a predetermined rotation axis by a drive unit 134 that operates based on the control from the controller 11. As a result, the laser beam L1 is horizontally scanned such that an angle of view SR of the laser beam L1 reflected by the galvano mirror 135 reciprocating scans in a distance measurement range AR in the horizontal direction (second direction). In other words, the drive unit 134 and the galvano mirror 135 function as a scanning unit that scans light emitted from the LD array 131 along the horizontal direction. Note that a micro electro mechanical system (MEMS), a micromotor, or the like can be used for the drive unit 134.

The laser beam L1 reflected by the galvano mirror 135 is reflected by the object 90 existing in the distance measurement range AR and enters the galvano mirror 135 as the reflected light L2. A part of the reflected light L2 incident on the galvano mirror 135 is transmitted through the half mirror 133 and incident on the light receiving lens 146, thereby forming an image on a specific SPAD array 142 in the SPAD array 141. Note that the SPAD array 142 may be the entire SPAD array 141 or a part thereof.

### 1.3 Light Receiving Unit

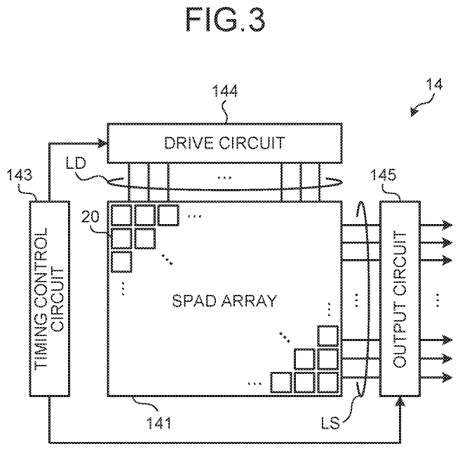

FIG. 3 is a block diagram illustrating a schematic configuration example of a light receiving unit according to the present embodiment. As illustrated in FIG. 3, the light receiving unit 14 includes a SPAD array 141, a timing control circuit 143, a drive circuit 144, and an output circuit 145.

The SPAD array 141 includes a plurality of SPAD pixels 20 arranged in a two-dimensional lattice pattern. To the plurality of SPAD pixels 20, a pixel drive line LD (vertical direction in the drawing) is connected for each column, and an output signal line LS (horizontal direction in the drawing) is connected for each row. One end of the pixel drive line LD is connected to an output end corresponding to each column of the drive circuit 144, and one end of the output signal line LS is connected to an input end corresponding to each row of the output circuit 145.

In the present embodiment, the reflected light L2 is detected using the entire or a part of the SPAD array 141. The region (SPAD array 142) used in the SPAD array 141 may be a rectangle that is long in the vertical direction and is the same as the image of the reflected light L2 formed on the SPAD array 141 when the entire laser beam L1 is reflected as the reflected light L2. However, the present invention is not limited thereto, and various modifications such as a region larger or a region smaller than the image of the reflected light L2 formed on the SPAD array 141 may be made.

The drive circuit 144 includes a shift register, an address decoder, and the like, and drives each SPAD pixel 20 of the SPAD array 141 at the same time for all pixels, in units of columns, or the like. Therefore, the drive circuit 144 includes at least a circuit that applies a quench voltage V_QCH to be described later to each SPAD pixel 20 in the select column in the SPAD array 141 and a circuit that applies a selection control voltage V_SEL to be described later to each SPAD pixel 20 in the select column. Then, the drive circuit 144 applies the selection control voltage V_SEL to the pixel drive line LD corresponding to the column to be read, thereby selecting the SPAD pixels 20 to be used for detecting incidence of photons in units of columns.

A signal (referred to as a detection signal) V_OUT output from each SPAD pixel 20 of the column selectively scanned by the drive circuit 144 is input to the output circuit 145 through each of the output signal lines LS. The output circuit 145 outputs the detection signal V_OUT input from each SPAD pixel 20 to the SPAD addition unit 40 provided for each macro pixel described later.

The timing control circuit 143 includes a timing generator or the like that generates various timing signals, and controls the drive circuit 144 and the output circuit 145 on the basis of the various timing signals generated by the timing generator.

### 1.4 LD Array and SPAD Array

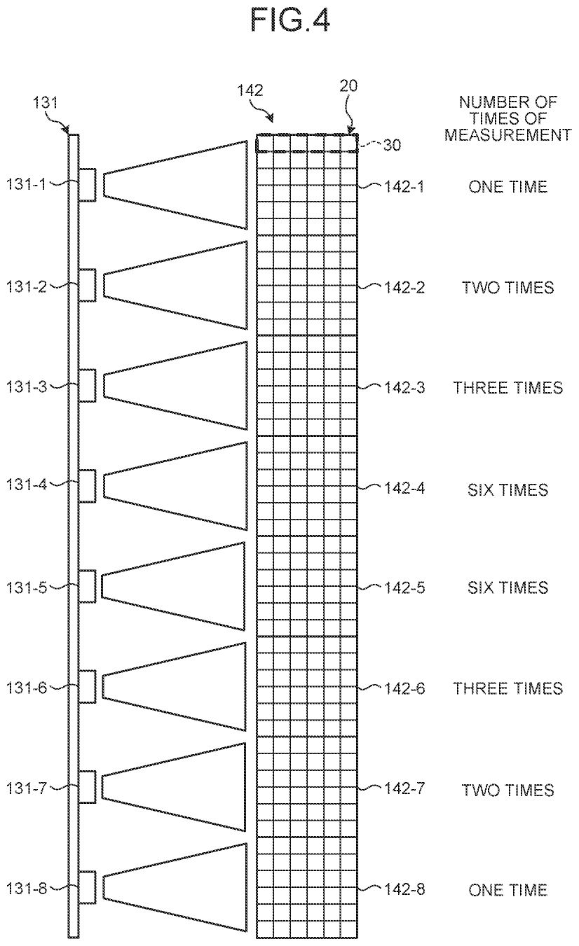

FIG. 4 is a schematic diagram illustrating a schematic configuration example of the LD array and the SPAD array according to the present embodiment. As illustrated in FIG. 4, the LD array 131 has a configuration in which, for example, LDs 131-1 to 131-8, which are a plurality of semiconductor laser diodes, are arranged in a one-dimensional array along a vertical direction. In the present embodiment, an example in which the LD array 131 includes eight LDs will be described, but the number of LDs only needs to be plural.

The SPAD array 142 has, for example, a configuration in which a plurality of SPAD pixels 20 is arranged in a two-dimensional lattice pattern. The plurality of SPAD pixels 20 are grouped into a plurality of macro pixels 30 each including a predetermined number of SPAD pixels 20 arranged in the row and/or column direction. The shape of the region connecting the outer edges of the SPAD pixels 20 located at the outermost periphery of each macro pixel 30 is a predetermined shape (for example, a rectangle).

The SPAD array 142 includes, for example, a plurality of macro pixels 30 arranged in the vertical direction (corresponding to the column direction). In the present embodiment, the SPAD array 142 is divided into a plurality of regions (hereinafter, referred to as a SPAD region) in the vertical direction, for example. In the example illustrated in FIG. 4, the SPAD array 142 is divided into eight SPAD regions 142-1 to 142-8 that receive the laser beams emitted from the LDs 131-1 to 131-8, respectively. The uppermost SPAD region 142-1 corresponds to, for example, the uppermost ⅛ region in the angle of view SR of the SPAD array 142, and receives the laser beam emitted from the LD 131-1. Similarly, the SPAD region 142-2 thereunder corresponds to, for example, the second ⅛ region from the top in the angle of view SR, and receives the laser beam emitted from the LD 131-2. Similarly, the SPAD regions 142-3 to 142-8 correspond to ⅛ regions in the angle of view SR, respectively, and receive the laser beams emitted from the LDs 131-3 to 131-8.

### 1.5 SPAD Pixel

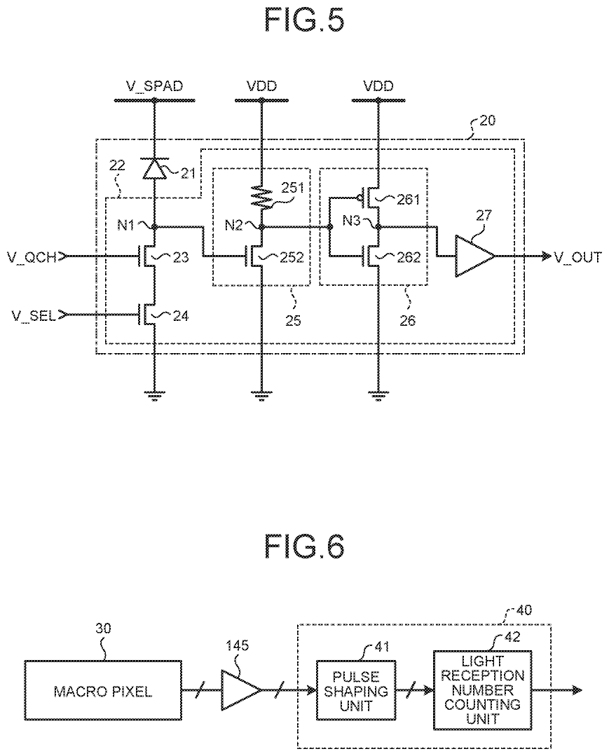

FIG. 5 is a circuit diagram illustrating a schematic configuration example of the SPAD pixel according to the present embodiment. As illustrated in FIG. 5, the SPAD pixel 20 includes a photodiode 21 as a light receiving element and a readout circuit 22 that detects incidence of a photon on the photodiode 21. When a photon enters the photodiode 21 in a state where a reverse bias voltage V_SPAD equal to or higher than a breakdown voltage is applied between an anode and a cathode of the photodiode, an avalanche current is generated.

The readout circuit 22 includes a quench resistor 23, a digital converter 25, an inverter 26, a buffer 27, and a selection transistor 24. The quench resistor 23 is, for example, an N-type metal oxide semiconductor field effect transistor (MOSFET: hereinafter referred to as an NMOS transistor), the drain of which is connected to the anode of the photodiode 21, and the source of which is grounded via the selection transistor 24. In addition, a quench voltage V_QCH set in advance for causing the NMOS transistor to act as a quench resistor is applied from the drive circuit 144 to the gate of the NMOS transistor constituting the quench resistor 23 via the pixel drive line LD.

In the present embodiment, the photodiode 21 is a SPAD. The SPAD is an avalanche photodiode that operates in Geiger mode when a reverse bias voltage equal to or higher than a breakdown voltage is applied between an anode and a cathode of the SPAD, and can detect incidence of one photon.

The digital converter 25 includes a resistor 251 and an NMOS transistor 252. A drain of the NMOS transistor 252 is connected to a power supply voltage VDD via the resistor 251, and a source thereof is grounded. In addition, a voltage at a connection point N1 between the anode of the photodiode 21 and the quench resistor 23 is applied to the gate of the NMOS transistor 252.

The inverter 26 includes a P-type MOSFET transistor (hereinafter, referred to as a PMOS transistor) 261 and an NMOS transistor 262. A drain of the PMOS transistor 261 is connected to the power supply voltage VDD, and a source thereof is connected to a drain of the NMOS transistor 262. The drain of the NMOS transistor 262 is connected to the source of the PMOS transistor 261, and a source thereof is grounded. A voltage at a connection point N2 between the resistor 251 and the drain of the NMOS transistor 252 is applied to the gate of the PMOS transistor 261 and the gate of the NMOS transistor 262, respectively. The output of the inverter 26 is input to the buffer 27.

The buffer 27 is a circuit for impedance conversion. When an output signal is input from the inverter 26, the buffer converts the impedance of the output signal that is input and outputs the converted signal as a detection signal V_OUT.

The selection transistor 24 is, for example, an NMOS transistor, a drain of which is connected to the source of the NMOS transistor constituting the quench resistor 23, and a source of which is grounded. The selection transistor 24 is connected to the drive circuit 144, and changes from the OFF state to the ON state when the selection control voltage V_SEL from the drive circuit 144 is applied to the gate of the selection transistor 24 via the pixel drive line LD.

### 1.6 Schematic Operation Example of SPAD Pixel

The readout circuit 22 illustrated in FIG. 5 operates as follows, for example. That is, first, during a period in which the selection control voltage V_SEL is applied from the drive circuit 144 to the selection transistor 24 and the selection transistor 24 is in the ON state, the reverse bias voltage V_SPAD equal to or higher than the breakdown voltage is applied to the photodiode 21. As a result, the operation of the photodiode 21 is permitted.

On the other hand, during a period in which the selection control voltage V_SEL is not applied from the drive circuit 144 to the selection transistor 24 and the selection transistor 24 is in the OFF state, the reverse bias voltage V_SPAD is not applied to the photodiode 21, so that the operation of the photodiode 21 is prohibited.

When a photon enters the photodiode 21 while the selection transistor 24 is in the ON state, an avalanche current is generated in the photodiode 21. As a result, an avalanche current flows through the quench resistor 23, and the voltage at the connection point N1 increases. When the voltage at the connection point N1 becomes higher than the ON state voltage of the NMOS transistor 252, the NMOS transistor 252 becomes in the on state, and the voltage at the connection point N2 changes from the power supply voltage VDD to 0 V. When the voltage at the connection point N2 changes from the power supply voltage VDD to 0 V, the PMOS transistor 261 changes from the OFF state to the ON state, the NMOS transistor 262 changes from the ON state to the OFF state, and the voltage at the connection point N3 changes from 0 V to the power supply voltage VDD. As a result, the high-level detection signal V_OUT is output from the buffer 27.

Thereafter, when the voltage at the connection point N1 continues to increase, the voltage applied between the anode and the cathode of the photodiode 21 becomes smaller than the breakdown voltage, whereby the avalanche current stops and the voltage at the connection point N1 decreases. Then, when the voltage at the connection point N1 becomes lower than the ON-state voltage of the NMOS transistor 252, the NMOS transistor 252 becomes in the OFF state, and the output of the detection signal V_OUT from the buffer 27 is stopped (low level).

As described above, the readout circuit 22 outputs the high-level detection signal V_OUT during a period from the timing at which the photon enters the photodiode 21 to generate the avalanche current, and the NMOS transistor 252 becomes in the ON state to the timing at which the avalanche current stops and the NMOS transistor 252 becomes in the OFF state. The output detection signal V_OUT is input to the SPAD addition unit 40 for each macro pixel 30 via the output circuit 145. Therefore, the detection signal V_OUT of the number (the number of detection) of SPAD pixels 20 in which the incidence of photons is detected among the plurality of SPAD pixels 20 constituting one macro pixel 30 is input to each SPAD addition unit 40.

### 1.7 SPAD Addition Unit

FIG. 6 is a block diagram illustrating a more detailed configuration example of the SPAD addition unit according to the present embodiment. Note that the SPAD addition unit 40 may be included in the light receiving unit 14 or may be included in the calculation unit 15.

As illustrated in FIG. 6, the SPAD addition unit 40 includes, for example, a pulse shaping unit 41 and a light reception number counting unit 42.

The pulse shaping unit 41 shapes the pulse waveform of the detection signal V_OUT input from the SPAD array 141 via the output circuit 145 into a pulse waveform having a time width according to the operation clock of the SPAD addition unit 40.

The light reception number counting unit 42 counts the detection signal V_OUT input from the corresponding macro pixel 30 for each sampling cycle, thereby counting the number (the number of detection) of the SPAD pixels 20 in which the incidence of photons is detected for each sampling cycle, and outputs the counted value as the pixel value of the macro pixel 30.

### 1.8 Sampling Cycle

Here, the sampling cycle is a cycle of measuring a time (time-of-flight) from when the light emitting unit 13 emits the laser beam L1 to when the light receiving unit 14 detects incidence of photons. As the sampling cycle, a cycle shorter than the light emission cycle of the light emitting unit 13 is set. For example, by shortening the sampling cycle, it is possible to calculate the time-of-flight of the photon emitted from the light emitting unit 13 and reflected by the object 90 with higher time resolution. This means that the distance to the object 90 can be calculated with a higher distance measurement resolution by increasing the sampling frequency.

For example, if a time-of-flight is set to t until when the light emitting unit 13 emits the laser beam L1, the laser beam L1 is reflected by the object 90, and the reflected light L2 is incident on the light receiving unit 14, distance L to the object 90 can be calculated as the following equation (1) since the light speed C is constant (C≈300,000,000 m (meters)/s (seconds)).

$$L = C \times t / 2 \qquad ( 1 )$$

Therefore, when the sampling frequency is 1 GHz, the sampling cycle is 1 ns (nanosecond). In that case, one sampling cycle corresponds to 15 cm (centimeter). This indicates that the distance measurement resolution is 15 cm when the sampling frequency is 1 GHz. In addition, when the sampling frequency is doubled to 2 GHz, the sampling cycle is 0.5 ns (nanoseconds), and thus one sampling cycle corresponds to 7.5 cm (centimeters). This indicates that the distance measurement resolution can be set to ½ when the sampling frequency is doubled. In this way, by increasing the sampling frequency and shortening the sampling cycle, the distance to the object 90 can be calculated more accurately.

### 1.9 Histogram

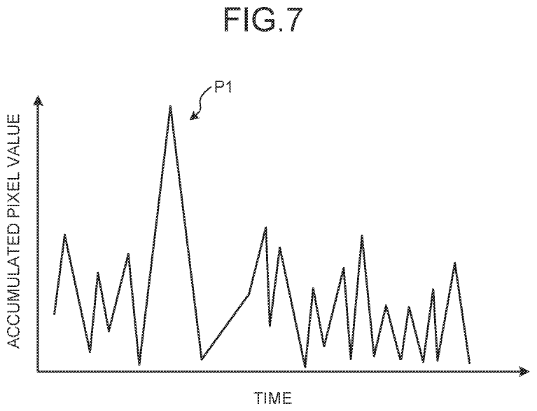

FIG. 7 illustrates a histogram generated by the above-described calculation unit 15. Specifically, FIG. 7 illustrates a gram obtained by linearizing a histogram in which the vertical axis represents an accumulated pixel value and the horizontal axis represents time (time-of-flight). As illustrated in FIG. 7, when there is the object 90 (see FIG. 1) in the region detected by the ToF sensor 1, a peak P1 corresponding to the object 90 that is a reflector appears in the histogram. The peak P1 has a peak width close to the pulse width of the laser beam L1.

### 1.10 Region to be Detected

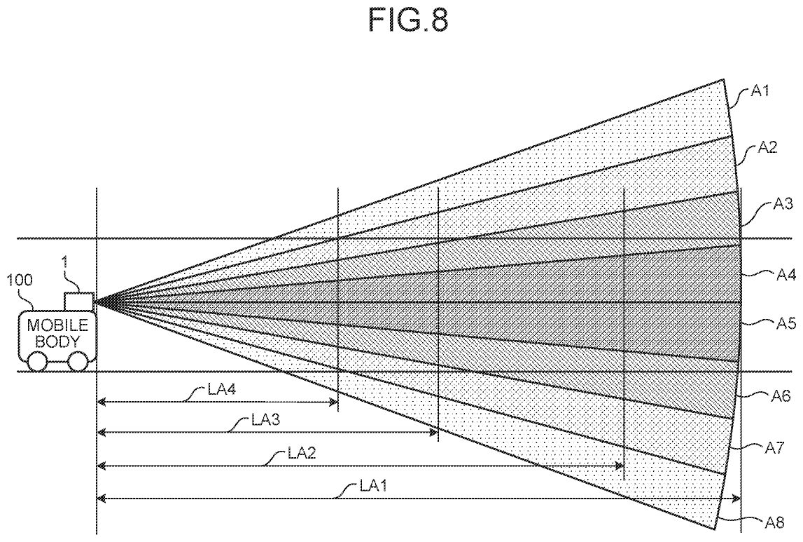

FIG. 8 is a diagram for explaining a region detected by the LD array and the SPAD array. As illustrated in FIG. 8, the ToF sensor 1 is installed in a mobile body 100 that is, for example, a vehicle. Each set of the LDs 131-1 to 131-8 and the SPAD regions 142-1 to 142-8 illustrated in FIG. 4 is used to measure the distance to the regions A1 to A8, respectively. In other words, the LDs 131-1 to 131-8 of the LD array 131 emit light at different angles along the vertical direction, and the SPAD regions 142-1 to 142-8 of the SPAD array 142 receive light from different angles along the vertical direction.

Specifically, the LD 131-1 emits laser beam toward the region A1, and the SPAD region 142-1 receives reflected light from the region A1. Similarly, the LD 131-2 emits laser beam toward the region A2, and the SPAD region 142-2 receives reflected light from the region A3. The LDs 131-3 to 131-8 similarly emit laser beam to the regions A3 to A8, respectively, and the SPAD regions 142-3 to 142-8 similarly receive reflected light from the regions A3 to A8, respectively. That is, the LDs 131-4 and 131-5 emit light in a direction in which the angle formed with the horizontal direction is the smallest, the LDs 131-3 and 131-6 emit light in a direction in which the angle formed with the horizontal direction is the smallest after the LDs 131-4 and 131-5, the LDs 131-2 and 131-7 emit light in a direction in which the angle formed with the horizontal direction is the smallest after the LDs 131-3 and 131-6, and the LDs 131-1 and 131-8 emit light in a direction in which the angle formed with the horizontal direction is the largest.

Here, in a case where the ToF sensor 1 is installed in the mobile body 100 that is a vehicle, since the region A4 and the region A5 correspond to the front of the mobile body 100, it is required to measure the distance to an object located several 10 m to several 100 m ahead, and the distance LA1 required to be detected is large. On the other hand, in the region A1 and the region A8, since it is not necessary to measure the sky and the ground, the distance LA4 required to be detected is small. As described above, the distance LA1 required to be detected in the region A4 and the region A5, the distance LA2 required to be detected in the region A3 and the region A6, the distance LA3 required to be detected in the region A2 and the region A7, and the distance LA4 required to be detected in the region A1 and the region A8 decrease in this order.

### 1.11 Number of Times of Detection

In the region A4 and the region A5 illustrated in FIG. 8, since the distance LA1 required to be detected is large, the distance to the detected object 90 may be long. In a case where the distance to the object 90 is long, the light amount of the peak P1 by the reflected light L2 illustrated in FIG. 7 is smaller than that in a case where the object 90 is close. When the light amount of the peak P1 is small and the peak P1 is buried in the ambient light, the distance may not be measured correctly. Note that the ambient light here is light caused by a surrounding environment such as sunlight.

The controller 11 performs control to increase the number of times of measurement as the distance required to be detected is larger. By increasing the number of times of measurement and integrating the detection results, the light amount of the peak P1 can be increased, the peak P1 due to the reflected light L2 can be prevented from being buried in the ambient light, and accurate distance measurement can be performed.

Specifically, the controller 11 calculates the distances LA1 to LA4 required to be detected in the regions A1 to A8 corresponding to the directions in which the LDs 131-1 to 131-8 emit light using the height from the ground to the installation position of the ToF sensor 1 and the installation angle with respect to the ground with reference to the horizontal. Then, the controller 11 determines the number of times of measurement according to the distances LA1 to LA4 required to be detected.

FIG. 4 illustrates an example of the number of times of measurement determined by the controller 11. Note that the controller 11 performs control such that the number of times of light emission of the LDs 131-1 to 131-8 and the number of times of light reception of the SPAD regions 142-1 to 142-8 respectively coincide with the number of times of measurement. In the regions A4 and A5 where the distance LA1 required to be detected is the largest, the controller 11 determines that the number of times of measurement (that is, the number of times of light emission and the number of times of light reception) is six times. Similarly, the number of times of measurement of the regions A3 and A6 is determined to be three times, the number of times of measurement of the regions A2 and A7 is determined to be two times, and the number of times of measurement of the regions A1 and A8 is determined to be one time in the descending order of the distances required to be detected. The total number of times of measurement is preferably set by determining the number of times of light emission based on the upper limit of the Laser safety standards, and is, for example, 24 times.

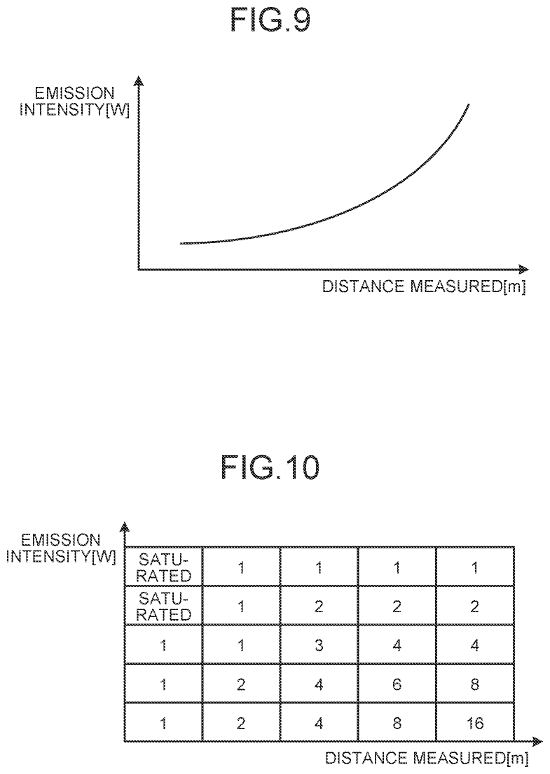

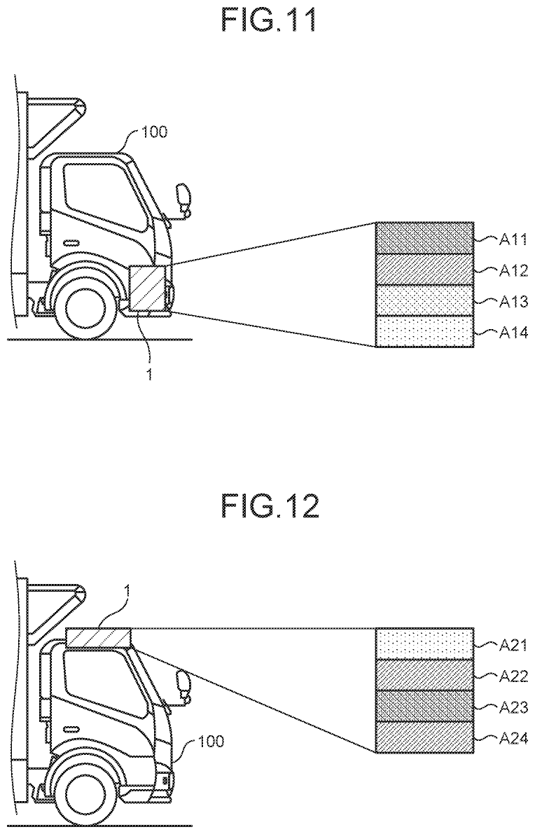

Note that by appropriately selecting the emission intensity in the light emitting unit 13, distance measurement can be performed with high accuracy. FIG. 9 is a diagram illustrating a relationship between distance measured and emission intensity. In FIG. 9, the horizontal axis represents distance measurable, and the vertical axis represents emission intensity of the light emitting unit 13. Due to the inverse square law regarding light attenuation, it is necessary to further increase the emission intensity in the case of distance measurement to a farther distance. FIG. 10 is a diagram illustrating a relationship between distance measured, emission intensity, and the number of times of measurement. In FIG. 10, the number of times of measurement required to accurately perform distance measurement at each distance measured and each light emission intensity is represented by numbers. As illustrated in FIG. 10, in a case where the emission intensity in the light emitting unit 13 is weak, accurate distance measurement can be performed by increasing the number of times of measurement and integrating the detection results a plurality of times. On the other hand, when the light emission intensity is increased, the distance can be accurately measured to a far place with few numbers of times of measurement, but the light receiving element of the light receiving unit 14 may be saturated in a region where the distance to be measured is short, and there is a possibility that the measurement cannot be accurately performed. Therefore, it is preferable to appropriately select the emission intensity in the light emitting unit 13 and perform highly accurate distance measurement.

Note that the controller 11 may determine the number of times of light emission according to the position where the ToF sensor 1 is installed. FIGS. 9 and 10 are diagrams illustrating installation positions of ToF sensors according to Modifications 1 and 2. As illustrated in FIG. 9, in a case where the ToF sensor 1 is installed below the mobile body 100 and the height from the ground to the installation position of the ToF sensor 1 is small, the number of times of light emission may be reduced in the order starting from the region A11 located at the uppermost position, then the region A12, the region A13, and the region A14. Similarly, as illustrated in FIG. 10, in a case where the ToF sensor 1 is installed above the mobile body 100 and the height from the ground to the installation position of the ToF sensor 1 is large, the number of times of light emission may be reduced in the order starting from the region A23 located second from the bottom, then the regions A22, A24, and A21.

Furthermore, the controller 11 may determine the number of times of light emission according to the speed at which the mobile body 100 in which the ToF sensor 1 is installed moves. For example, in a case where the mobile body 100 moves at a high speed, it is necessary to measure the distance in front of the mobile body to a farther distance, and thus the controller 11 performs control to increase the number of times of light emission in the regions A4 and A5 in front of the mobile body. Furthermore, for example, in a case where the mobile body 100 is moving at a low speed, the controller 11 performs control to increase the number of times of light emission in the upper regions A1 to A4 in order to measure a distance of an object located above the mobile body 100 such as a signboard or a ceiling.

In addition, the controller 11 may determine the number of times of light emission according to the position information of the mobile body 100 in which the ToF sensor 1 is installed. For example, in a case where the position of the mobile body 100 indicated by the position information is a slope, the controller 11 may determine the number of times of light emission in the regions A1 to A8 according to the inclination of the slope. Note that the controller 11 acquires position information including the latitude, longitude, and altitude of the vehicle generated by the mobile body 100 which received a global navigation satellite system (GNSS) signal from a GNSS satellite (for example, a global positioning system (GPS) signal from a GPS satellite) and executed positioning.

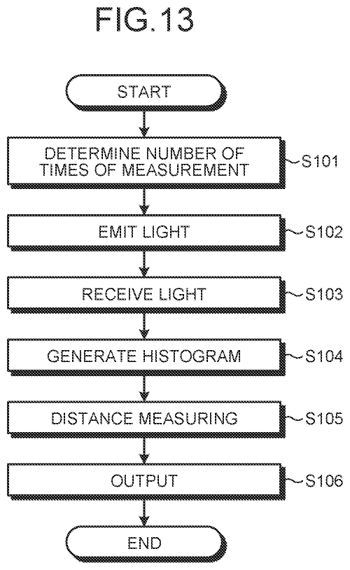

Next, a procedure of processing executed by the ToF sensor 1 will be described using FIG. 13. FIG. 13 is a flowchart illustrating a processing procedure of entire processing executed by the ToF sensor 1.

As illustrated in FIG. 13, the controller 11 determines the number of times of measurement in the regions A1 to A8 (Step S101). Specifically, the controller 11 determines the number of times of measurement of the regions A1 to A8 as illustrated in FIG. 4.

Subsequently, the light emitting unit 13 emits the laser beam L1 by emitting light (Step S102).

Then, the light receiving unit 14 receives the reflected light L2 that is the laser beam L1 being reflected by the object 90 (Step S103).

Thereafter, the calculation unit 15 generates a histogram of the accumulated pixel values based on the detection signal output from the light receiving unit 14 (Step S104).

Then, the controller 11 calculates the distance to the object 90 on the basis of the generated histogram (Step S105).

Subsequently, the controller 11 outputs the calculated distance to the host 80 (Step S106), and ends the processing.

### 2. APPLICATION EXAMPLE

The technology according to the present disclosure can be applied to various products. For example, the technology according to the present disclosure may be realized as a device mounted on any type of mobile body such as automobiles, electric vehicles, hybrid electric vehicles, motorcycles, bicycles, personal mobilities, airplanes, drones, ships, robots, construction machines, or agricultural machines (tractors).

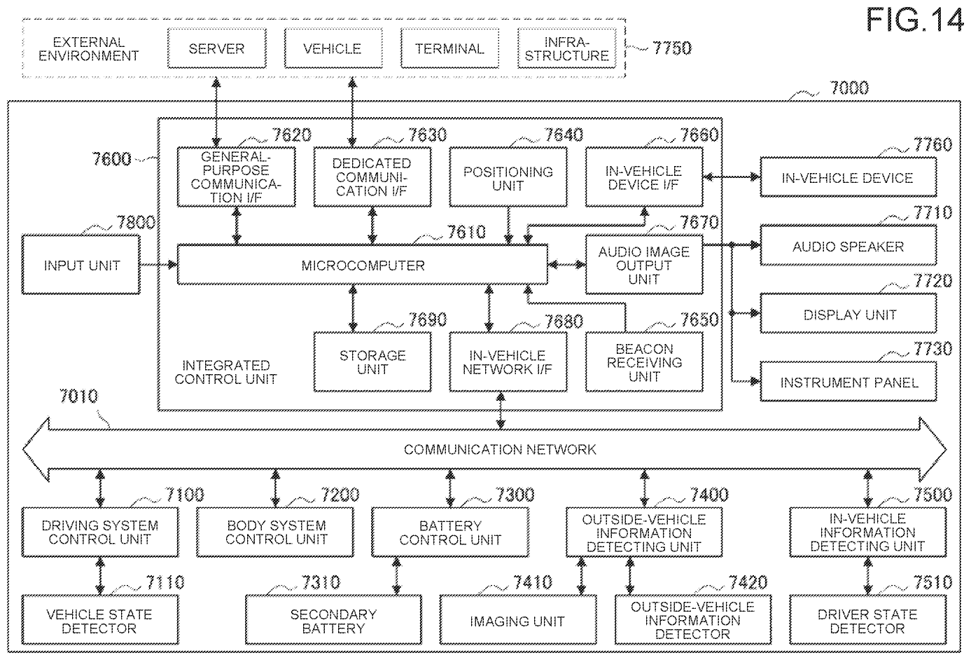

FIG. 14 is a block diagram illustrating a schematic configuration example of a vehicle control system 7000 which is an example of a mobile body control system to which a technology according to the present disclosure is applicable. The vehicle control system 7000 includes a plurality of electronic control units connected to each other via a communication network 7010. In the example illustrated in FIG. 14, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units may be, for example, an in-vehicle communication network conforming to an arbitrary standard such as a controller area network (CAN), a local interconnect network (LIN), a local area network (LAN), or FlexRay (registered trademark).

Each control unit includes a microcomputer that performs arithmetic processing according to various programs, a storage unit that stores programs executed by the microcomputer, parameters used for various calculations, or the like, and a drive circuit that drives various devices to be controlled. Each control unit includes a network I/F for communicating with other control units via the communication network 7010, and a communication I/F for communicating with devices, sensors, or the like inside and outside the vehicle by wired communication or wireless communication. In FIG. 14, as a functional configuration of the integrated control unit 7600, a microcomputer 7610, a general-purpose communication I/F 7620, a dedicated communication I/F 7630, a positioning unit 7640, a beacon receiving unit 7650, an in-vehicle device I/F 7660, an audio image output unit 7670, an in-vehicle network I/F 7680, and a storage unit 7690 are illustrated. The other control units similarly include a microcomputer, a communication I/F, a storage unit, and the like.

The driving system control unit 7100 controls the operation of devices related to the driving system of the vehicle in accordance with various programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device such as an antilock brake system (ABS) or an electronic stability control (ESC).

A vehicle state detector 7110 is connected to the driving system control unit 7100. The vehicle state detector 7110 includes, for example, at least one of a gyro sensor that detects an angular velocity of axial rotational motion of a vehicle body, an acceleration sensor that detects acceleration of the vehicle, or a sensor for detecting an operation amount of an accelerator pedal, an operation amount of a brake pedal, a steering angle of a steering wheel, an engine speed, a wheel rotation speed, or the like. The driving system control unit 7100 performs arithmetic processing using a signal input from the vehicle state detector 7110, and controls an internal combustion engine, a driving motor, an electric power steering device, a brake device, or the like.

The body system control unit 7200 controls the operation of various kinds of devices provided to a vehicle body in accordance with various programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls the secondary battery 7310, which is a power supply source of the driving motor, according to various programs. For example, information such as a battery temperature, a battery output voltage, or a remaining capacity of a battery is input to the battery control unit 7300 from a battery device including the secondary battery 7310. The battery control unit 7300 performs arithmetic processing using these signals, and performs temperature adjustment control of the secondary battery 7310 or control of a cooling device or the like included in the battery device.

The outside-vehicle information detecting unit 7400 detects information about the outside of the vehicle including the vehicle control system 7000. For example, at least one of an imaging unit 7410 and an outside-vehicle information detector 7420 is connected to the outside-vehicle information detecting unit 7400. The imaging unit 7410 includes at least one of a time of flight (ToF) camera, a stereo camera, a monocular camera, an infrared camera, or other cameras. The outside-vehicle information detector 7420 includes, for example, at least one of an environment sensor for detecting current weather or climate, or a surrounding information detection sensor for detecting another vehicle, an obstacle, a pedestrian, or the like around the vehicle on which the vehicle control system 7000 is mounted.

The environment sensor may be, for example, at least one of a raindrop sensor that detects rainy weather, a fog sensor that detects fog, a sunshine sensor that detects a degree of sunshine, and a snow sensor that detects snowfall. The surrounding information detection sensor may be at least one of an ultrasonic sensor, a radar device, or a light detection and ranging, laser imaging detection and ranging (LIDAR) device. The imaging unit 7410 and the outside-vehicle information detector 7420 may be provided as independent sensors or devices, or may be provided as a device in which a plurality of sensors or devices is integrated.

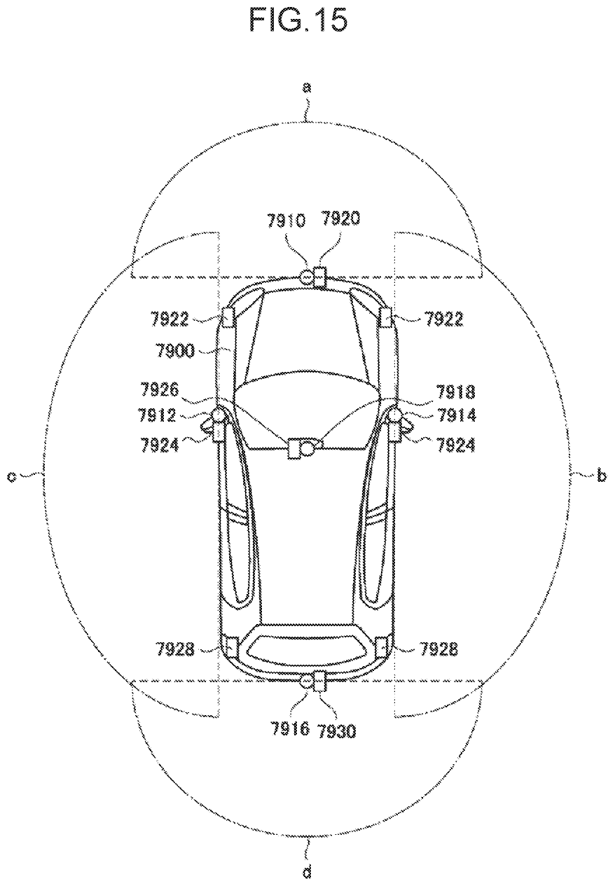

Here, FIG. 15 is a diagram illustrating an example of installation positions of the imaging unit 7410 and the outside-vehicle information detector 7420. Imaging units 7910, 7912, 7914, 7916, and 7918 are positioned at, for example, at least any one of the front nose, a side mirror, the rear bumper, the back door, and the upper part of the windshield in the vehicle compartment of the vehicle 7900. The imaging unit 7910 provided to the front nose and the imaging unit 7918 provided to the upper part of the windshield in the vehicle compartment obtain mainly an image of the front of the vehicle 7900. The imaging units 7912 and 7914 attached to the side mirrors obtain mainly images of the areas on the sides of the vehicle 7900. The imaging unit 7916 provided to the rear bumper or the back door obtains mainly an image of the rear of the vehicle 7900. The imaging unit 7918 provided to the upper part of the windshield in the vehicle compartment is used mainly to detect a preceding vehicle, a pedestrian, an obstacle, a signal, a traffic sign, a lane, or the like.

Additionally, FIG. 15 illustrates an example of the imaging ranges of the respective imaging units 7910, 7912, 7914, and 7916. An imaging range a represents the imaging range of the imaging unit 7910 provided to the front nose. Imaging ranges b and c respectively represent the imaging ranges of the imaging units 7912 and 7914 provided to the side mirrors. An imaging range d represents the imaging range of the imaging unit 7916 provided to the rear bumper or the back door. A bird's-eye image of the vehicle 7900 as viewed from above is obtained by superimposing image data imaged by the imaging units 7910, 7912, 7914, and 7916, for example.

The outside-vehicle information detectors 7920, 7922, 7924, 7926, 7928, and 7930 provided at the front, rear, sides, corners, and the upper part of the windshield in the vehicle compartment of the vehicle 7900 may be, for example, ultrasonic sensors or radar devices. The outside-vehicle information detectors 7920, 7926, and 7930 provided at the front nose, the rear bumper, the back door, and the upper part of the windshield in the vehicle compartment of the vehicle 7900 may be, for example, LIDAR devices. These outside-vehicle information detectors 7920 to 7930 are mainly used for detecting a preceding vehicle, a pedestrian, an obstacle, or the like.

Returning to FIG. 14, the description will be continued. The outside-vehicle information detecting unit 7400 makes the imaging unit 7410 image an image of the outside of the vehicle, and receives the imaged image data. Furthermore, the outside-vehicle information detecting unit 7400 receives detection information from the connected outside-vehicle information detector 7420. In a case where the outside-vehicle information detector 7420 is an ultrasonic sensor, a radar device, or a LIDAR device, the outside-vehicle information detecting unit 7400 transmits ultrasonic waves, electromagnetic waves, or the like, and receives information of received reflected waves. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing rainfall, fog, road surface conditions, or the like on the basis of the received information. The outside-vehicle information detecting unit 7400 may calculate a distance to an object outside the vehicle on the basis of the received information.

Furthermore, on the basis of the received image data, the outside-vehicle information detecting unit 7400 may perform processing of image recognition for recognizing a human, a vehicle, an obstacle, a sign, a character on a road surface, or the like, or processing of detecting a distance thereto. The outside-vehicle information detecting unit 7400 may perform processing such as distortion correction or alignment on the received image data, and combine image data captured by different imaging units 7410 to generate a bird's-eye view image or a panoramic image. The outside-vehicle information detecting unit 7400 may perform viewpoint conversion processing using image data captured by different imaging units 7410.

The in-vehicle information detecting unit 7500 detects information about the inside of the vehicle. The in-vehicle information detecting unit 7500 is, for example, connected with a driver state detector 7510 that detects the state of a driver. The driver state detector 7510 may include a camera that images the driver, a biological sensor that detects biological information of the driver, a microphone that collects sound in the vehicle compartment, or the like. The biological sensor is provided, for example, on a seat surface, a steering wheel, or the like, and detects biological information of the passenger sitting on a seat or the driver holding the steering wheel. On the basis of detection information input from the driver state detector 7510, the in-vehicle information detecting unit 7500 may calculate a degree of fatigue of the driver or a degree of concentration of the driver, or may determine whether the driver is dozing. The in-vehicle information detecting unit 7500 may perform processing such as noise canceling processing on the collected sound signal.

The integrated control unit 7600 controls the overall operation in the vehicle control system 7000 in accordance with various programs. An input unit 7800 is connected to the integrated control unit 7600. The input unit 7800 is realized by, for example, a device that can be operated by an occupant for input, such as a touch panel, a button, a microphone, a switch, or a lever. Data obtained by performing voice recognition on the voice input by the microphone may be input to the integrated control unit 7600. The input unit 7800 may be, for example, a remote control device using infrared rays or other radio waves, or an external connection device such as a mobile phone or a personal digital assistant (PDA) corresponding to the operation of the vehicle control system 7000. The input unit 7800 may be, for example, a camera, and in this case, the passenger can input information by gesture. Alternatively, data obtained by detecting the movement of the wearable device worn by the passenger may be input. Furthermore, the input unit 7800 may include, for example, an input control circuit or the like that generates an input signal on the basis of information input by the passenger or the like using the input unit 7800 and outputs the input signal to the integrated control unit 7600. By operating the input unit 7800, the passenger or the like inputs various data to the vehicle control system 7000 or instructs a processing operation.

The storage unit 7690 may include a read only memory (ROM) that stores various programs to be executed by the microcomputer, and a random access memory (RAM) that stores various parameters, calculation results, sensor values, or the like. In addition, the storage unit 7690 may be realized by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various devices existing in an external environment 7750. The general-purpose communication I/F 7620 may implement a cellular communication protocol such as Global System of Mobile communications (GSM) (registered trademark), WiMAX (registered trademark), Long Term Evolution (LTE) (registered trademark), or LTE-Advanced (LTE-A), or other wireless communication protocols such as a wireless LAN (also referred to as Wi-Fi (registered trademark)) and Bluetooth (registered trademark). The general-purpose communication I/F 7620 may be connected to a device (for example, an application server or a control server) existing on an external network (for example, the Internet, a cloud network, or a company-specific network) via, for example, a base station or an access point. Furthermore, the general-purpose communication I/F 7620 may be connected to a terminal (for example, a terminal of a driver, a pedestrian, or a store, or a machine type communication (MTC) terminal) existing in the vicinity of the vehicle using, for example, a peer to peer (P2P) technology.

The dedicated communication I/F 7630 is a communication I/F that supports a communication protocol formulated for use in a vehicle. For example, the dedicated communication I/F 7630 may implement a standard protocol such as wireless access in vehicle environment (WAVE) which is a combination of IEEE 802.11p of the lower layer and IEEE 1609 of the upper layer, dedicated short range communications (DSRC), or a cellular communication protocol. The dedicated communication I/F 7630 typically performs V2X communication which is a concept including one or more of vehicle to vehicle communication, vehicle to infrastructure communication, vehicle to home communication, and vehicle to pedestrian communication.

The positioning unit 7640 receives, for example, a global navigation satellite system (GNSS) signal from a GNSS satellite (for example, a global positioning system (GPS) signal from a GPS satellite), executes positioning, and generates position information including the latitude, longitude, and altitude of the vehicle. Note that the positioning unit 7640 may specify the current position by exchanging signals with a wireless access point, or may acquire the position information from a terminal such as a mobile phone, a PHS, or a smartphone having a positioning function.

The beacon receiving unit 7650 receives, for example, radio waves or electromagnetic waves transmitted from a wireless station or the like installed on a road, and acquires information such as a current position, a traffic jam, a closed road, a required time, or the like. Note that the function of the beacon receiving unit 7650 may be included in the dedicated communication I/F 7630 described above.

The in-vehicle device I/F 7660 is a communication interface that mediates connection between the microcomputer 7610 and various in-vehicle devices 7760 existing in the vehicle. The in-vehicle device I/F 7660 may establish wireless connection using a wireless communication protocol such as wireless LAN, Bluetooth (registered trademark), near field communication (NFC), or wireless USB (WUSB). Furthermore, the in-vehicle device I/F 7660 may establish wired connection such as universal serial bus (USB), high-definition multimedia interface (HDMI) (registered trademark), or mobile high-definition link (MHL) via a connection terminal (and, if necessary, a cable.) not illustrated. The in-vehicle device 7760 may include, for example, at least one of a mobile device or a wearable device possessed by the passenger, or an information device carried in or attached to the vehicle. Furthermore, the in-vehicle device 7760 may include a navigation device that searches for a route to an arbitrary destination. The in-vehicle device I/F 7660 exchanges a control signal or a data signal with these in-vehicle devices 7760.

The in-vehicle network I/F 7680 is an interface that mediates communication between the microcomputer 7610 and the communication network 7010. The in-vehicle network I/F 7680 transmits and receives signals and the like in accordance with a predetermined protocol supported by the communication network 7010.

The microcomputer 7610 of the integrated control unit 7600 controls the vehicle control system 7000 according to various programs on the basis of information acquired via at least one of the general-purpose communication I/F 7620, the dedicated communication I/F 7630, the positioning unit 7640, the beacon receiving unit 7650, the in-vehicle device I/F 7660, or the in-vehicle network I/F 7680. For example, the microcomputer 7610 may calculate a control target value for the driving force generating device, the steering mechanism, or the braking device on the basis of the information about the inside or outside of the vehicle to be obtained, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the information about the obtained information of surroundings of the vehicle which information is obtained.

The microcomputer 7610 may generate three-dimensional distance information between the vehicle and an object such as a surrounding structure or a person on the basis of information acquired via at least one of the general-purpose communication I/F 7620, the dedicated communication I/F 7630, the positioning unit 7640, the beacon receiving unit 7650, the in-vehicle device I/F 7660, or the in-vehicle network I/F 7680, and create local map information including surrounding information of the current position of the vehicle. Furthermore, the microcomputer 7610 may predict danger such as collision of the vehicle, approach of a pedestrian or the like, or entry into a closed road on the basis of the acquired information, and generate a warning signal. The warning signal may be, for example, a signal for generating a warning sound or turning on a warning lamp.

The audio image output unit 7670 transmits an output signal of at least one of a sound or an image to an output device capable of visually or auditorily notifying an occupant of the vehicle or the outside of the vehicle of information. In the example of FIG. 14, an audio speaker 7710, a display unit 7720, and an instrument panel 7730 are exemplified as the output device. The display unit 7720 may, for example, include at least one of an on-board display or a head-up display. The display unit 7720 may have an augmented reality (AR) display function. The output device may be another device other than these devices, such as a wearable device such as a headphone or an eyeglass-type display worn by a passenger, a projector, or a lamp. In a case where the output device is a display device, the display device visually displays results obtained by various processes performed by the microcomputer 7610 or information received from another control unit in various formats such as text, images, tables, and graphs. Furthermore, in a case where the output device is a sound output device, the sound output device converts an audio signal including reproduced sound data, acoustic data, or the like into an analog signal and aurally outputs the analog signal.

Note that, in the example illustrated in FIG. 14, at least two control units connected via the communication network 7010 may be integrated as one control unit. Alternatively, each control unit may include a plurality of control units. Further, the vehicle control system 7000 may include another control unit (not illustrated). In the above description, some or all of the functions performed by any of the control units may be provided to another control unit. That is, as long as information is transmitted and received via the communication network 7010, predetermined arithmetic processing may be performed by any control unit. Similarly, a sensor or a device connected to any of the control units may be connected to another control unit, and a plurality of control units may mutually transmit and receive detection information via the communication network 7010.

Note that a computer program for realizing each function of the ToF sensor 1 according to the present embodiment described with reference to FIG. 1 can be mounted on any control unit or the like. Furthermore, it is also possible to provide a computer-readable recording medium storing such a computer program. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, the ToF sensor 1 according to the present embodiment described with reference to FIG. 1 can be applied to the integrated control unit 7600 of the application example illustrated in FIG. 14. For example, the controller 11, the calculation unit 15, and the external I/F 19 of the ToF sensor 1 correspond to the microcomputer 7610, the storage unit 7690, and the in-vehicle network I/F 7680 of the integrated control unit 7600. However, the present invention is not limited thereto, and the vehicle control system 7000 may correspond to the host 80 in FIG. 1.

Furthermore, at least some components of the ToF sensor 1 described with reference to FIG. 1 may be realized in a module (for example, an integrated circuit module including one die) for the integrated control unit 7600 illustrated in FIG. 14. Alternatively, the ToF sensor 1 described with reference to FIG. 1 may be realized by a plurality of control units of the vehicle control system 7000 illustrated in FIG. 14.

### 3. SUMMARY

As described above, according to an embodiment of the present disclosure, the light source device 2 according to the present embodiment includes the light emitting unit 13, the scanning unit (the drive unit 134 and the galvano mirror 135), and the controller 11. In the light emitting unit 13, a plurality of light emitting elements is arranged along a first direction (vertical direction). The galvano mirror 135 is driven by the drive unit 134, and scans light emitted from the plurality of light emitting elements along the second direction (horizontal direction) orthogonal to the first direction. The controller 11 performs control to make the number of times of light emission of the first light emitting element group included in the plurality of light emitting elements larger than the number of times of light emission of the second light emitting element group not included in the first light emitting element group. As a result, the number of times of light emission for an important region along the vertical direction is increased, and measurement can be performed with high accuracy.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Furthermore, the effects of the embodiments described in the present specification are merely examples and are not limited, and other effects may be provided.

Furthermore, the effects described in the present specification are merely examples and are not limited, and other effects may be provided.

Note that the present technology can also have the following configurations.

(1)

A light source device, comprising:
a light emitting unit in which a plurality of light emitting elements are arranged along a first direction;
a scanning unit that scans light emitted from the plurality of light emitting elements along a second direction orthogonal to the first direction; and
a controller that performs control to make the number of times of light emission of a first light emitting element group included in the plurality of light emitting elements larger than the number of times of light emission of a second light emitting element group not included in the first light emitting element group.

(2)

The light source device according to (1), wherein the controller performs control to increase the number of times of light emission as the distance required to be detected is larger.

(3)

The light source device according to (1) or (2), wherein the light emitting unit emits light at different angles along a vertical direction.

(4)

The light source device according to any one of (1) to (3), wherein the first light emitting element group is a light emitting element that emits light in a direction in which an angle with a horizontal direction is smaller than that of the second light emitting element group.

(5)

The light source device according to any one of (1) to (4), wherein
the first direction is a vertical direction, and
the second direction is a horizontal direction.

(6)

The light source device according to any one of (1) to (5), wherein the light source device is installed on a mobile body.

(7)

The light source device according to any one of (1) to (6), wherein the controller determines the number of times of light emission according to a position where the light source device is installed.

(8)

The light source device according to (6) or (7), wherein the controller determines the number of times of light emission according to a speed at which the mobile body moves.

(9)

The light source device according to any one of (6) to (8), wherein the controller determines the number of times of light emission according to position information of the mobile body.

(10)

A distance measuring device, comprising:
a light emitting unit in which a plurality of light emitting elements are arranged along a first direction;
a scanning unit that scans light emitted from the plurality of light emitting elements along a second direction orthogonal to the first direction;
a controller that performs control to make the number of times of light emission of a first light emitting element group included in the plurality of light emitting elements larger than the number of times of light emission of a second light emitting element group not included in the first light emitting element group; and
a light receiving unit in which a plurality of light receiving elements are arranged along the first direction and each of the light receiving elements receives light from the plurality of light emitting elements.

(11)

The distance measuring device according to (10), wherein
the controller performs control to:
make the number of times of light reception of a light receiving element that receives light from the first light emitting element group to be the same as the number of times of light emission of the first light emitting element group; and
make the number of times of light reception of a light receiving element that receives light from the second light emitting element group to be the same as the number of times of light emission of the second light emitting element group.

(12)

A distance measuring method executed by a distance measuring device including:
a light emitting unit in which a plurality of light emitting elements are arranged along a first direction;
a scanning unit that scans light emitted from the plurality of light emitting elements along a second direction orthogonal to the first direction; and
a light receiving unit in which a plurality of light receiving elements are arranged along the first direction and each of the light receiving elements receives light from the plurality of light emitting elements, the method comprising a control step of performing control to make the number of times of light emission of a first light emitting element group included in the plurality of light emitting elements larger than the number of times of light emission of a second light emitting element group not included in the first light emitting element group.

(13)

The distance measuring method according to (12), wherein
the control step is to perform control to:
make the number of times of light reception of a light receiving element that receives light from the first light emitting element group to be the same as the number of times of light emission of the first light emitting element group; and
make the number of times of light reception of a light receiving element that receives light from the second light emitting element group to be the same as the number of times of light emission of the second light emitting element group.

### REFERENCE SIGNS LIST

1 ToF SENSOR (DISTANCE MEASURING DEVICE)
2 LIGHT SOURCE DEVICE
11 CONTROLLER
13 LIGHT EMITTING UNIT
14 LIGHT RECEIVING UNIT
15 CALCULATION UNIT
20 SPAD PIXEL
30 MACRO PIXEL
80 HOST
90 OBJECT

1. A light source device, comprising:
a light emitting unit in which a plurality of light emitting elements are arranged along a first direction;
a scanning unit that scans light emitted from the plurality of light emitting elements along a second direction orthogonal to the first direction; and
a controller that performs control to make the number of times of light emission of a first light emitting element group included in the plurality of light emitting elements larger than the number of times of light emission of a second light emitting element group not included in the first light emitting element group.

2. The light source device according to claim 1, wherein the controller performs control to increase the number of times of light emission as the distance required to be detected is larger.

3. The light source device according to claim 1, wherein the light emitting unit emits light at different angles along a vertical direction.

4. The light source device according to claim 3, wherein the first light emitting element group is a light emitting element that emits light in a direction in which an angle with a horizontal direction is smaller than that of the second light emitting element group.

5. The light source device according to claim 1, wherein
the first direction is a vertical direction, and
the second direction is a horizontal direction.

6. The light source device according to claim 1, wherein the light source device is installed on a mobile body.

7. The light source device according to claim 6, wherein the controller determines the number of times of light emission according to a position where the light source device is installed.

8. The light source device according to claim 6, wherein the controller determines the number of times of light emission according to a speed at which the mobile body moves.

9. The light source device according to claim 6, wherein the controller determines the number of times of light emission according to position information of the mobile body.

10. A distance measuring device, comprising:
a light emitting unit in which a plurality of light emitting elements are arranged along a first direction;
a scanning unit that scans light emitted from the plurality of light emitting elements along a second direction orthogonal to the first direction;
a controller that performs control to make the number of times of light emission of a first light emitting element group included in the plurality of light emitting elements larger than the number of times of light emission of a second light emitting element group not included in the first light emitting element group; and
a light receiving unit in which a plurality of light receiving elements are arranged along the first direction and each of the light receiving elements receives light from the plurality of light emitting elements.

11. The distance measuring device according to claim 10, wherein
the controller performs control to:
make the number of times of light reception of a light receiving element that receives light from the first light emitting element group to be the same as the number of times of light emission of the first light emitting element group; and
make the number of times of light reception of a light receiving element that receives light from the second light emitting element group to be the same as the number of times of light emission of the second light emitting element group.

12. A distance measuring method executed by a distance measuring device including:
a light emitting unit in which a plurality of light emitting elements are arranged along a first direction;
a scanning unit that scans light emitted from the plurality of light emitting elements along a second direction orthogonal to the first direction; and
a light receiving unit in which a plurality of light receiving elements are arranged along the first direction and each of the light receiving elements receives light from the plurality of light emitting elements, the method comprising
a control step of performing control to make the number of times of light emission of a first light emitting element group included in the plurality of light emitting elements larger than the number of times of light emission of a second light emitting element group not included in the first light emitting element group.

13. The distance measuring method according to claim 12, wherein
the control step is to perform control to:
make the number of times of light reception of a light receiving element that receives light from the first light emitting element group to be the same as the number of times of light emission of the first light emitting element group; and
make the number of times of light reception of a light receiving element that receives light from the second light emitting element group to be the same as the number of times of light emission of the second light emitting element group.
